(19) United States
(12) Patent Application Publication
(10) Pub. No.: US 2026/0237293 A1
(43) Pub. Date: Aug. 13, 2026

(54) DEVICE AND METHOD FOR INFERRING DRIVING TENDENCIES OF A VEHICLE

(71) Applicant: FOUNDATION OF SOONGSIL UNIVERSITY-INDUSTRY COOPERATION, Seoul (KR)

(72) Inventors: MINHAE KWON, Seoul (KR); SANGEUN PARK, Seoul (KR); CHANIN EOM, Seoul (KR)

(21) Appl. No.: 19/184,029

(22) Filed: Apr. 21, 2025

(30) Foreign Application Priority Data
Feb. 12, 2025 (KR) 10-2025-0018300

(51) Int. Cl. G08G 1/01

(52) U.S. Cl. CPC G08G 1/0112

(57) ABSTRACT

A device for inferring driving tendencies of the vehicle includes an information collection module configured to collect traveling information of a target vehicle and an observation vehicle within an observable range of the observation vehicle, a preprocessing module configured to preprocess the collected traveling information to generate processed information including observation vehicle-related information, target vehicle-related information, and observable range-related information, and an inference module configured to input the processed information into a pre-trained artificial neural network model to infer driving tendencies of the target vehicle.

### CROSS REFERENCE TO RELATED APPLICATIONS AND CLAIM OF PRIORITY

This application claims the benefit under 35 USC § 119 (a) of Korean Patent Application No. 10-2025-0018300 filed on Feb. 12, 2025 in the Korean Intellectual Property Office, the entire disclosure of which is incorporated herein by reference for all purposes.

### BACKGROUND

### 1. Field

Embodiments of the present disclosure relate to a technology for inferring driving tendencies of a vehicle on a road.

### 2. Description of Related Art

Recently, with the growth of autonomous driving technology, discussions on the commercialization of autonomous vehicles continue to take place. The commercialization of autonomous vehicles naturally creates a road environment where autonomous vehicles and non-autonomous vehicles are mixed and traveled. If the driving tendencies of adjacent vehicles may be identified in such a road environment, not only can the driving stability of both autonomous vehicles and non-autonomous vehicles be improved, but also the flow of traffic can be made smooth, and thus a method for identifying the driving tendencies of adjacent vehicles is required.

Examples of related art include Republic of Korea registered patent publication No. 10-2492637 (2023.01.30).

### SUMMARY

Embodiments of the present disclosure are intended to provide a device and method for inferring driving tendencies of a vehicle.

According to an exemplary embodiment of the present disclosure, there is provided a device for inferring driving tendencies of a vehicle installed in an observation vehicle, including an information collection module configured to collect traveling information of a target vehicle and an observation vehicle within an observable range of the observation vehicle, a preprocessing module configured to preprocess the collected traveling information to generate processed information including observation vehicle-related information, target vehicle-related information, and observable range-related information, and an inference module configured to input the processed information into a pre-trained artificial neural network model to infer driving tendencies of the target vehicle.

The information collection module may be configured to collect the traveling information through one or more observation means provided in the observation vehicle, and collect the traveling information for a preset time length and store the traveling information in a buffer in the form of a queue.

The observation vehicle-related information may include a speed of the observation vehicle, a position of the observation vehicle, and a current lane of the observation vehicle.

The target vehicle-related information may include a relative lane of the target vehicle and forward and rearward positions of the target vehicle, the relative lane of the target vehicle may indicate which lane the target vehicle is positioned in among a left-hand lane, a right-hand lane, and the same lane based on the observation vehicle, and the forward and rearward positions of the target vehicle may indicate whether the target vehicle is positioned forward or rearward based on the observation vehicle.

The observable range-related information may include a relative speed of adjacent vehicles for each lane within the observable range, a relative distance of adjacent vehicles for each lane, the density for each forward lane, and a travelable distance for each forward lane.

The device for inferring driving tendencies of a vehicle may further include a training module configured to collect traveling information about vehicles to construct a training dataset and train the artificial neural network model using the training dataset.

The training module may be configured to generate, when no label for driving tendencies of a vehicle of interest is present in training data, classification basic information including one or more of a relative distance from a vehicle ahead in the same lane as the vehicle of interest, a speed of the vehicle of interest, lateral acceleration of the vehicle of interest, and longitudinal acceleration of the vehicle of interest based on traveling information of the vehicle of interest for which no label for the driving tendencies is present, classify the vehicle of interest into one of preset clusters using the classification basic information, and generate a pseudo label according to the classified cluster.

The training module may be configured to add noise to each training data to learn about noise generated during a sensing process.

The training module may be configured to add noise with smaller noise as a distance between the observation vehicle and the target vehicle is closer to each training data, and add noise with larger noise as the distance between the observation vehicle and the target vehicle is farther to each training data.

According to another exemplary embodiment of the present disclosure, there is provided a method for inferring driving tendencies of a vehicle performed by a computing device installed in an observation vehicle and including one or more processors and a memory storing one or more programs executed by the one or more processors, the method including collecting traveling information of a target vehicle and an observation vehicle within an observable range of the observation vehicle, preprocessing the collected traveling information to generate processed information including observation vehicle-related information, target vehicle-related information, and observable range-related information, and inputting the processed information into a pre-trained artificial neural network model to infer driving tendencies of the target vehicle.

### BRIEF DESCRIPTION OF THE DRAWINGS

FIG. 1 is a diagram showing a device for inferring driving tendencies for a vehicle on a road according to an embodiment of the present disclosure.

FIG. 2 is a diagram for describing processed information in an embodiment of the present disclosure.

FIGS. 3A to 3D are diagrams illustrating a state of inferring driving tendencies in various types of artificial neural network models according to an embodiment of the present disclosure.

FIGS. 4A and 4B are diagrams illustrating a state of clustering classification basic information of a vehicle in an embodiment of the present disclosure.

FIG. 5 is a block diagram for illustratively describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or workers. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In addition, the terms “first”, “second”, etc. may be used to describe various components, but the components should not be limited by the terms. The terms may be used to distinguish one component from another. For example, without departing from the scope of the present disclosure, a first component may be referred to as a second component, and similarly, a second component may also be referred to as a first component.

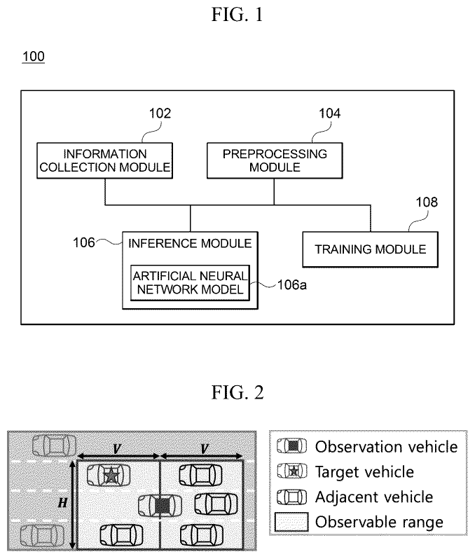

FIG. 1 is a diagram showing a device for inferring driving tendencies of a vehicle on a road according to an embodiment of the present disclosure. Referring to FIG. 1, a device for inferring driving tendencies of a vehicle 100 may include an information collection module 102, a preprocessing module 104, an inference module 106, and a training module 108. The device for inferring driving tendencies of a vehicle 100 may be installed in a vehicle and infer driving tendencies of an adjacent vehicle on the road. In an embodiment, a vehicle in which the device for inferring driving tendencies of a vehicle 100 is installed may be an autonomous vehicle, but is not limited thereto and may also include a non-autonomous vehicle.

In the disclosed embodiment, the driving tendencies of the vehicle may mean driving tendencies of a driver driving a vehicle. In this case, the driving tendencies may include a traveling pattern that appears when the driver directly operates the vehicle or a traveling pattern that appears in the vehicle by the driver's traveling command (e.g., settings for autonomous traveling input by the driver).

In an embodiment, the driving tendencies may be divided into a conservative tendency, a neutral tendency, and an aggressive tendency. The conservative tendency may be a driving tendency of having a stopping distance between vehicles, maintaining stable traveling even in a situation where traffic congestion is low, and minimizing lane change. The neutral tendency may be a driving tendency of having a shorter stopping distance between vehicles than that of the conservative tendency, stably performing traveling in case of traffic congestion, and performing traveling to achieve a target speed in a smooth road environment. The aggressive tendency may be a driving tendency of having a shorter stopping distance between vehicles than that of the neutral tendency, maintaining high speed while following the acceleration of a vehicle ahead, and frequently changing lanes. Here, the stopping distance between vehicles may mean a distance between a vehicle in question and a vehicle ahead in the same lane.

The information collection module 102 may collect traveling information about a target vehicle on the road within an observable range of a vehicle (hereinafter, referred to as an observation vehicle) in which the device for inferring driving tendencies of a vehicle 100 is installed. Here, the target vehicle may include all adjacent vehicles positioned within the observable range of the observation vehicle.

The information collection module 102 may be equipped with observation means such as a camera, radar, and a measurement sensor to collect the traveling information of the target vehicle. In the disclosed embodiment, the observation vehicle collects the traveling information of the adjacent vehicle within the direct observable range. Here, the observable range of the observation vehicle may be determined by a range that the observation means may observe.

The information collection module 102 may collect the traveling information of the target vehicle through one or more observation means. The information collection module 102 may recognize a vehicle number to identify each target vehicle. The information collection module 102 may collect traveling information including the position of the target vehicle, the lane of the target vehicle on the road, the speed of the target vehicle, etc. In addition, the information collection module 102 may collect the traveling information of the observation vehicle (the position of the observation vehicle, speed of the observation vehicle, lane of the observation vehicle on the road, etc.).

In an embodiment, the information collection module 102 may collect traveling information of the target vehicle and the observation vehicle at preset time intervals. In this case, the collected traveling information may be trajectory data having a preset time length. The trajectory data may be defined as time series data including data of each time step from a specific point in time to a point in time at which a predetermined time elapses. In this case, a time length of the trajectory data may be determined by the type, performance, accuracy, etc. of an artificial neural network model described below. The information collection module 102 is equipped with a buffer in the form of a queue to temporarily store trajectory data having a preset time length.

The preprocessing module 104 may preprocess the traveling information of the target vehicle and the observation vehicle having the preset time length. The preprocessing module 104 may process the traveling information of the target vehicle and the observation vehicle having a preset time length into information for training or inferring the artificial neural network model. The artificial neural network model may be a model trained to infer the driving tendencies of the target vehicle.

The preprocessing module 104 may preprocess the traveling information of the target vehicle and the observation vehicle having a preset time length to generate processed information in units of preset time steps. Here, the processed information may include observation vehicle-related information, target vehicle-related information, and observable range-related information. FIG. 2 is a diagram for describing processed information in an embodiment of the present disclosure, and FIG. 2 illustrates an observable range based on an observation vehicle.

Meanwhile, processed information oₜ at time step t may be represented by Equation 1 below.

$${o}_{t} = {[ {o}_{t , ego}^{T} , {o}_{t , target}^{T} , {o}_{t , obs}^{T} ]}^{T} \qquad Equation 1$$

o_{t,ego}: observation vehicle-related information
o_{t,target}: target vehicle-related information
o_{t,obs}: observable range-related information

Here, the observation vehicle-related information may include the speed of the observation vehicle, the position of the observation vehicle, and the current lane of the observation vehicle. The observation vehicle-related information may be represented by Equation 2.

$${o}_{t , ego} = {[ {v}_{t , ego} , {p}_{t , ego} , {h}_{t , ego} ]}^{T} \qquad Equation 2$$

v_{t,ego}: speed of observation vehicle
p_{t,ego}: position of observation vehicle
h_{t,ego}: current lane of observation vehicle

In addition, the target vehicle-related information may include a relative lane of the target vehicle and forward and rearward positions of the target vehicle. The relative lane of the target vehicle is information indicating whether the target vehicle exists in a left-hand lane, a right-hand lane, or the same lane based on the observation vehicle. The forward and rearward positions of the target vehicle are information indicating whether the target vehicle exists forward or rearward based on the observation vehicle. The target vehicle-related information may be represented by Equation 3.

$${o}_{t , target} = {[ {h}_{t , target} , {b}_{t , target} ]}^{T} \qquad Equation 3$$

h_{t,target}: relative lane of target vehicle
b_{t,targe}t: forward and rearward positions of target vehicle

For example, when the target vehicle is positioned in the left-hand lane relative to the observation vehicle, the relative lane of target vehicle information may be represented by h_{t,target}=h_{t,ego}+1. When the target vehicle is positioned in the right-hand lane relative to the observation vehicle, the relative lane of target vehicle information may be represented by h_{t,target}=h_{t,ego}−1. When the target vehicle is positioned in the same lane as the observation vehicle, the relative lane of target vehicle information may be represented by h_{t,target}=h_{t,ego}.

In addition, the forward and rearward positions of the target vehicle may be calculated by a difference between the position of the observation vehicle and the position of the target vehicle, that is, Δp_{t,target}=p_{t,target}−p_{t,ego}. Here, p_{t,target} indicates the position of the target vehicle. The forward and rearward positions of the target vehicle may be represented by Equation 4 below.

$${b}_{t , target} = \{ \begin{matrix}+ 1 & if Δ {p}_{t , target} \geq 0 \\ - 1 & if Δ {p}_{t , target} < 0\end{matrix} \qquad Equation 4$$

According to Equation 4, when the target vehicle is positioned forward the observation vehicle, b_{t,target} may be set to +1, and when the target vehicle is positioned behind the observation vehicle, b_{t,target} may be set to −1.

In addition, the observable range-related information may include information about vehicles and space within the observable range of the observation vehicle that may affect the behavior of the target vehicle. In an embodiment, the observable range-related information may include a relative speed of an adjacent vehicle for each lane, a relative distance of the adjacent vehicle for each lane, the density for each forward lane, and a travelable distance for each forward lane. The observable range-related information may be represented by Equation 5.

$${o}_{t , obs} = {[ Δ {v}_{t}^{T} , Δ {p}_{t , T} , {ρ}_{t}^{T} , {ζ}_{t}^{T} ]}^{T} \qquad Equation 5$$

Δvₜ: relative speed of adjacent vehicle for each lane
Δpₜ: relative distance of adjacent vehicle for each lane
pₜ: density for each forward lane:
ζₜ: travelable distance for each forward lane

Here, the relative speed of the adjacent vehicle for each lane may mean the relative speed of each adjacent vehicle within a preset observable range to the observation vehicle. The relative speed of adjacent vehicle for each lane Δvₜ may be represented by Δvₜ=[Δv_{t,l}_{₁}, . . . , Δv_{t,l}_{_{H}}, Δv_{t,f}_{₁}, . . . , Δv_{t,f}_{_{H}}]^{T}. The observable range may be a region set based on the position of the observation vehicle (e.g., a region in the shape of a square or a circle). In an embodiment, the observable range may be set through an area H corresponding to a certain number of lanes and a certain distance between forward and rearward points 2V based on the position of the observation vehicle.

The relative distance of the adjacent vehicle for each lane may mean a distance between each adjacent vehicle and the observation vehicle within a preset observable range. The relative distance to the adjacent vehicle for each lane Δpₜ may be represented by Δpₜ=[Δp_{t,l}_{₁}, . . . , Δp_{t,l}_{_{H}}, Δp_{t,f}_{₁}, . . . , Δp_{t,f}_{_{H}}]^{T}.

The density for each forward lane pₜ may mean the density of vehicles for each lane in the forward side of the observation vehicle within the preset observable range. The density for each forward lane p_{t,h} for lane h may be represented by

$${ρ}_{t , h} ∝ \frac{\vert {K}_{t , {l}_{h}} \vert}{V} .$$

|K_{t,l}_{ₕ}| means the number of vehicles positioned forward of the observation vehicle in each lane h within the observable range. V means a preset forward distance within the observable range based on the observation vehicle.

The travelable distance for each forward lane may mean a travelable road length of each lane extending in the forward direction of the target vehicle within the preset observable range. The travelable distance for each forward lane ζₜ may be represented by ζₜ=[ζ_{t,1}, ζ_{t,2}, . . . , ζ_{t,H}]^{T}. The travelable distance for each forward lane may be defined as +V when the lane is maintained within the observable range, and may be defined as 0 when the lane does not exist. When the travelable road length is shorter than a forward observation range, ζₜ may be defined in the range of [0, +V].

In an embodiment, the preprocessing module 104 may construct processed information in units of time steps for a preset time period as time series data. That is, the preprocessing module 104 may combine processed information in units of time steps for a certain time period to be constructed as trajectory data, which is time series data. The preprocessing module 104 may construct time series data including processed information in units of time steps for a certain time period from a specific point in time α to T time. In this case, the time series data may be represented by

$${\{ {o}_{t} \}}_{t = α}^{α + T} .$$

Time series data (i.e., trajectory data) for a certain time period may be used as input to the artificial neural network model. However, the preset disclosure is not limited thereto, and processed information of each time step may become input of the artificial neural network model depending on the type of the artificial neural network model.

The inference module 106 may infer the driving tendencies of the target vehicle by inputting the processed information (processed information for a certain time period or processed information for each time step) generated by the preprocessing module 104 into a pre-trained artificial neural network model 106a. When all adjacent vehicles within the observable range of the observation vehicle are set as target vehicles, the driving tendencies of all adjacent vehicles within the observable range may be inferred and utilized for decision-making regarding the traveling of the observation vehicle.

The training module 108 may play a role in training the artificial neural network model 106a for inferring the driving tendencies of the vehicle. The training module 108 may collect traveling information about vehicles on the road (including both vehicles on actual roads and vehicles on roads in a virtual environment) and construct a training dataset for training the artificial neural network model 106a. In this case, traveling information for vehicles may be collected using vehicles (autonomous vehicles or non-autonomous vehicles, etc.), but is not limited thereto, and may also be collected through a drone or simulator, etc.

The training module 108 may preprocess traveling information of a vehicle having a preset time length and generate processed information in units of preset time steps. The processed information may include observation vehicle-related information, target vehicle-related information, and observable range-related information. The training module 108 may train the artificial neural network model 106a based on the generated processed information.

The artificial neural network model 106a may be trained to classify the driving tendencies of the vehicle using processed information as input. In an embodiment, the artificial neural network model 106a may be a model based on one of a Transformer, a Long Short Term Memory (LSTM), and an extended LSTM (xLSTM). In this case, the processed information input to the artificial neural network model 106a may be processed information for a certain time period (i.e., trajectory data having a certain time length)

$${\{ {o}_{t} \}}_{t = α}^{α + T} .$$

However, the present disclosure is not limited thereto, and the artificial neural network model 106a may be a multi-layer perceptron (MLP). In this case, the processed information input to the artificial neural network model 106a may be processed information at each time step, i.e., processed information for a single point in time.

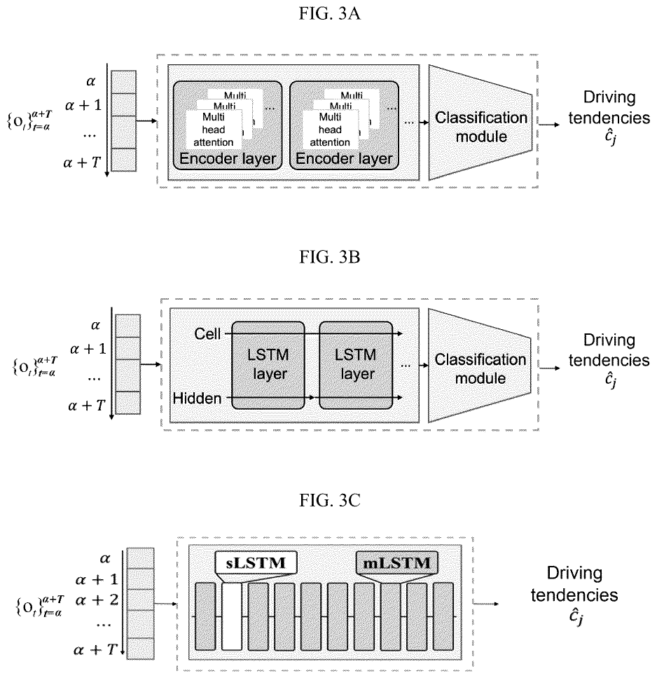

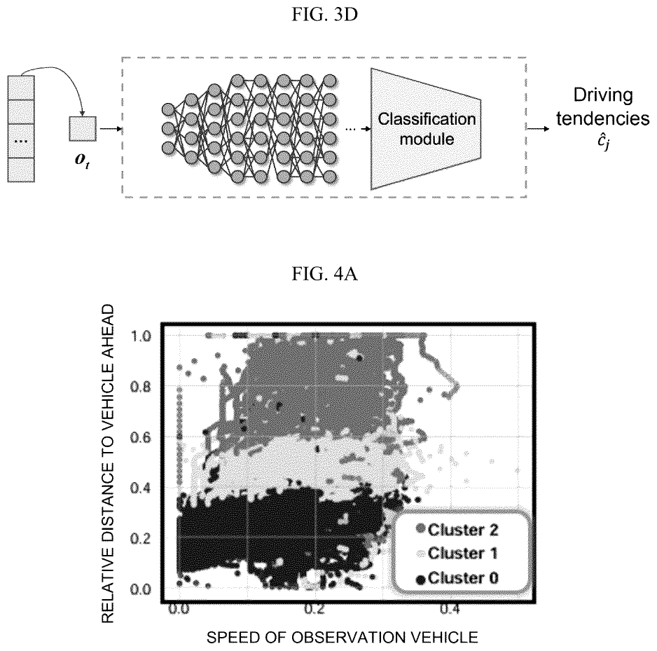

FIGS. 3A to 3D are diagrams showing a state of inferring driving tendencies in various types of artificial neural network models according to an embodiment of the present disclosure. FIGS. 3A to 3C respectively show cases where the artificial neural network model 106a is the transformer, the Long Short Term Memory (LSTM), and the extended LSTM (xLSTM). In this case, the processed information

$${\{ {o}_{t} \}}_{t = α}^{α + T} ,$$

which is trajectory data for a certain time period, is input to the artificial neural network model 106a, and the driving tendencies of the vehicle are inferred from the input processed information.

FIG. 3D shows the case where the artificial neural network model 106a is the multi-layer perceptron (MLP), and the processed information at each time step is input to the artificial neural network model 106a, and the driving tendencies of the vehicle are inferred from the input processed information. Hereinafter, for convenience of description, it will be described as an example that data input to the artificial neural network model 106a is processed information for a predetermined time period.

When training the artificial neural network model 106a, the training module 108 may generate a pseudo label for a vehicle of interest when no label for the driving tendencies of the vehicle of interest is present in the training data. Specifically, the training module 108 may generate a pseudo label for the driving tendencies for the vehicle of interest based on the traveling information of the vehicle for which no label for the driving tendencies is present.

The training module 108 may generate classification basic information for classifying the pseudo label of the vehicle of interest for which no label is present based on the traveling information of the vehicle. Here, the classification basic information may include the relative distance from a vehicle ahead in the same lane as a vehicle of interest, the speed of the vehicle of interest, the lateral acceleration of the vehicle of interest, and the longitudinal acceleration of the vehicle of interest. The training module 108 may input classification basic information of the vehicle of interest into the K-means clustering algorithm to generate a pseudo label for the vehicle of interest.

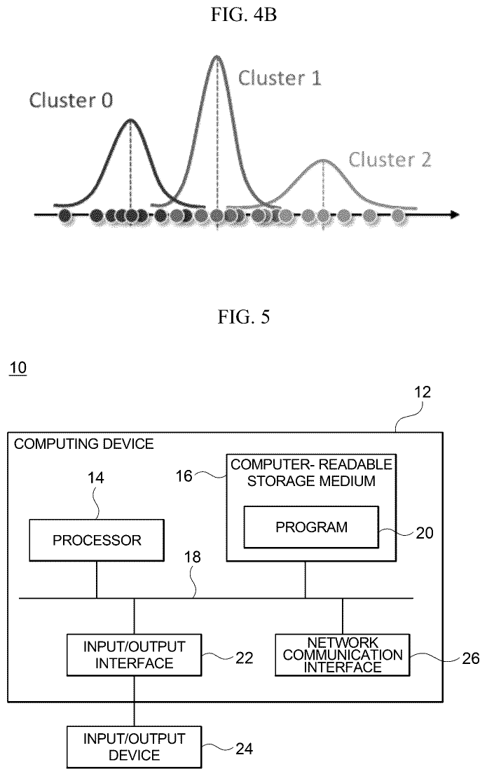

In addition, the training module 108 may input the classification basic information of the vehicle of interest into a Gaussian mixture model to classify clusters and generate a pseudo label through this classification. FIGS. 4A and 4B are diagrams showing a state of clustering classification basic information of a vehicle in an embodiment of the present disclosure. FIG. 4A shows a case where the K-means clustering is used, and FIG. 4B shows a case where clustering is done using a Gaussian mixture model. In the above two methods, the vehicle of interest may be classified into any one of clusters of Cluster 0 (conservative tendency), Cluster 1 (neutral tendency), and Cluster 2 (aggressive tendency), and a pseudo label may be generated according to the classified cluster.

The training module 108 may add noise to the training data when training the artificial neural network model 106a. That is, when collecting traveling information about a vehicle traveling on the road, since noise may be contained in the traveling information in a sensing process, noise may be intentionally added to training data for noise-robust training. By training the artificial neural network model 106a through training data with added noise in this way, the driving tendencies of the vehicle can be effectively inferred even if noise is contained in information collected when inferring the driving tendencies of the vehicle.

In an embodiment, when processed information for a certain time period is used as training data, the training module 108 may generate processed information containing noise through Equation 6 below.

$${\{ {\tilde{o}}_{t} \}}_{t = α}^{α + T} ← {\{ {o}_{t} \}}_{t = α}^{α + T} + Noise \qquad Equation 6$$

$${\{ {\tilde{o}}_{t} \}}_{t = α}^{α + T} :$$

processed information for a certain time period that contains noise

Here, the noise may be Gaussian noise. Gaussian noise is represented by

$$𝒩 ( 0 , {σ}_{t}^{2} ) ,$$

and may be randomly sampled from a normal distribution with a mean of 0 and a variance of

$${σ}_{t}^{2} .$$

That is, processed information may be generated by adding noise based on Gaussian distribution sampling. In addition, the noise may be set according to the distance between the observation vehicle and the target vehicle. That is, the closer the distance between the observation vehicle and the target vehicle, the smaller the noise, and the farther the distance between the observation vehicle and the target vehicle, the greater the noise.

In an embodiment, the training module 108 may input processed information containing noise into the artificial neural network model 106a and train the artificial neural network model 106a to infer the driving tendencies of the vehicle of interest. In this case, as a loss function for training the artificial neural network model 106a, a cross entropy loss function may be used. The artificial neural network model 106a may be trained through a process of Equation 7 below.

$$f ← f - η ∇ {ℒ}_{C E} ( ( {\{ {\tilde{o}}_{t} \}}_{t = α}^{α + T} , {c}_{j} ) ; f ) \qquad Equation 7$$

f: artificial neural network model
η: learning rate
[symbol] _{CE}: cross entropy loss function
cⱼ: correct answer class (correct answer value) for driving tendencies of vehicle

According to the disclosed embodiment, by inferring the driving tendencies of the target vehicle within the observable range on the road, each vehicle can travel in consideration of the driving tendencies of adjacent vehicles, and as a result, a smooth traffic flow can be induced on the road. In particular, in the case of autonomous vehicles, appropriate decisions are made accordingly in consideration of the driving tendencies of adjacent vehicles, and as a result, a safe traffic environment can be established. That is, the distance from the vehicle ahead or the number of lane changes may be different depending on the driving tendencies and even vehicles in the same situation may show different behavior patterns depending on the driving tendencies, and thus it is possible to grasp driving tendencies of other vehicles and utilize the driving tendencies for decision-making according to vehicle operation.

In this specification, the term “module” may mean a functional and structural combination of hardware for performing the technical idea of the present invention and software for operating the hardware. For example, the “module” may mean a logical unit of a given code and hardware resources for performing the given code, and does not necessarily mean a physically connected code or a single type of hardware.

FIG. 5 is a block diagram for illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In an embodiment, the computing device 12 may be the device for inferring driving tendencies of a vehicle 100. That is, the computing device 12 may be a device for inferring driving tendencies of a vehicle by being installed in the vehicle.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, by inferring the driving tendencies of the target vehicle on the road, each vehicle can travel in consideration of the driving tendencies of adjacent vehicles, and as a result, a smooth traffic flow can be induced on the road. In particular, in the case of autonomous vehicles, appropriate decisions are made in consideration of the driving tendencies of adjacent vehicles, and as a result, a safe traffic environment can be established.

In the above, although representative embodiments of the present invention have been described in detail, those skilled in the art will understand that the present disclosure may be implemented in modified forms without departing from the essential characteristics of the present disclosure. Therefore, the scope of the present disclosure is not limited to the embodiments described above, but should be defined not only by the claims described below but also by equivalents of the claims.

What is claimed is:

1. A device for inferring driving tendencies of a vehicle, the device configured to be installed in an observation vehicle, the device comprising:
an information collection module configured to collect traveling information of a target vehicle and an observation vehicle within an observable range of the observation vehicle;
a preprocessing module configured to preprocess the collected traveling information to generate processed information including observation vehicle-related information, target vehicle-related information, and observable range-related information; and
an inference module configured to input the processed information into a pre-trained artificial neural network model to infer driving tendencies of the target vehicle.

2. The device of claim 1, wherein the information collection module is configured to collect the traveling information through one or more observation means provided in the observation vehicle, and collect the traveling information for a preset time length and store the traveling information in a buffer of queue type.

3. The device of claim 1, wherein the observation vehicle-related information includes a speed of the observation vehicle, a position of the observation vehicle, and a current lane of the observation vehicle.

4. The device of claim 3, wherein the target vehicle-related information includes a relative lane of the target vehicle and forward and rearward positions of the target vehicle,
the relative lane of the target vehicle indicates which lane the target vehicle is positioned in among a left-hand lane, a right-hand lane, and the same lane based on the observation vehicle, and
the forward and rearward positions of the target vehicle indicate whether the target vehicle is positioned forward or rearward based on the observation vehicle.

5. The device of claim 4, wherein the observable range-related information includes a relative speed of adjacent vehicles for each lane within the observable range, a relative distance of adjacent vehicles for each lane, the density for each forward lane, and a travelable distance for each forward lane.

6. The device of claim 1, further comprising:
a training module configured to collect traveling information about vehicles to construct a training dataset and train the artificial neural network model using the training dataset.

7. The device of claim 6, wherein the training module is configured to generate, when no label for driving tendencies of a vehicle of interest is present in training data, classification basic information including one or more of a relative distance from a vehicle ahead in the same lane as the vehicle of interest, a speed of the vehicle of interest, lateral acceleration of the vehicle of interest, and longitudinal acceleration of the vehicle of interest based on traveling information of the vehicle of interest for which no label for the driving tendencies is present, classify the vehicle of interest into one of preset clusters using the classification basic information, and generate a pseudo label according to the classified cluster.

8. The device of claim 6, wherein the training module is configured to add noise to each training data to learn about noise generated during a sensing process.

9. The device of claim 8, wherein the training module is configured to add noise to each training data with smaller noise as a distance between the observation vehicle and the target vehicle is closer, and add noise to each training data with larger noise as the distance between the observation vehicle and the target vehicle is farther.

10. A method for inferring driving tendencies of a vehicle performed by a computing device installed in an observation vehicle and including one or more processors and a memory storing one or more programs executed by the one or more processors, the method comprising:
collecting traveling information of a target vehicle and an observation vehicle within an observable range of the observation vehicle;
preprocessing the collected traveling information to generate processed information including observation vehicle-related information, target vehicle-related information, and observable range-related information; and
inputting the processed information into a pre-trained artificial neural network model to infer driving tendencies of the target vehicle.

11. A computer program stored in a non-transitory computer readable storage medium and including one or more instructions, which, when executed by a computing device including one or more processors, cause the computing device to perform:
collecting traveling information of a target vehicle and an observation vehicle within an observable range of the observation vehicle;
preprocessing the collected traveling information to generate processed information including observation vehicle-related information, target vehicle-related information, and observable range-related information; and
inputting the processed information into a pre-trained artificial neural network model to infer driving tendencies of the target vehicle.
